(19) United States
(12) Patent Application Publication
(10) Pub. No.: US 2013/0143056 A1
(43) Pub. Date: Jun. 6, 2013

(54) PHOTO-VINYL LINKING AGENTS

(71) Applicants: Dale G. Swan, St. Louis Park, MN (US); Aleksey V. Kurdyumov, Maplewood, MN (US); Bruce M. Jelle, Chanhassen, MN (US)

(72) Inventors: Dale G. Swan, St. Louis Park, MN (US); Aleksey V. Kurdyumov, Maplewood, MN (US); Bruce M. Jelle, Chanhassen, MN (US)

(73) Assignee: SURMODICS, INC., Eden Prairie, MN (US)

(21) Appl. No.: 13/490,994

(22) Filed: Jun. 7, 2012

Related U.S. Application Data
(60) Provisional application No. 61/494,724, filed on Jun. 8, 2011.

(51) Int. Cl. C09D 4/00; C07F 9/40

(52) U.S. Cl. CPC C09D 4/00; C07F 9/4078
USPC 428/523; 427/517; 558/170

(57) ABSTRACT

Embodiments of the invention include linking agents including photo groups and vinyl groups and coatings and devices that incorporate such linking agents, along with related methods. Exemplary methods herein include methods of priming substrates and methods of coating substrates using compounds having the formula R¹—X—R², wherein R¹ is a radical comprising a vinyl group, X is a radical comprising from about one to about twenty carbon atoms, and R² is a radical comprising a photoreactive group. Embodiments herein also include linking agents having the formula R¹—X—R², wherein R¹ is a radical comprising a vinyl group, X is a radical comprising from about one to about twenty carbon atoms, and R² is a radical comprising a photoreactive group. Other embodiments are also included herein.

This application claims the benefit of U.S. Provisional Application No. 61/494,724, filed Jun. 8, 2011, the content of which is herein incorporated by reference in its entirety.

### FIELD OF THE INVENTION

The present invention relates to linking agents. More specifically, the present invention relates to linking agents including photoreactive groups and vinyl groups, and coatings and devices that incorporate such linking agents, along with related methods.

### BACKGROUND OF THE INVENTION

Photochemically reactive functional groups (“photoreactive groups” or “photogroups”) are functional groups that, when exposed to an appropriate energy source, undergo a transformation from an inactive state (i.e., ground state) to a reactive intermediate capable of forming covalent bonds with appropriate materials. Photoreactive groups can be used, for instance, to derivatize a target molecule in order to then photochemically attach the derivatized target molecule to a surface. Photoreactive groups can also be used as photoinitiators for polymerization reactions.

Vinyl groups exhibit reactivity including, but not limited to, electrophilic and free-radical addition. As such, vinyl groups can be used in processes such as free-radical vinyl polymerization.

### SUMMARY OF THE INVENTION

Embodiments of the invention include linking agents including photoreactive groups and vinyl groups and coatings and devices that incorporate such linking agents, along with related methods. In an embodiment, the invention includes a device including a substrate and a linking agent bound to the surface of the substrate through the residue of a photoreactive group, the linking agent having the formula R¹—X—R², wherein R¹ is a radical comprising a vinyl group, X is a radical comprising from about one to about twenty carbon atoms, and R² is a radical comprising a photoreactive group.

In an embodiment the invention includes a device comprising a substrate; a linking agent having the formula R¹—X—R², wherein R¹ is a radical comprising a vinyl group, X is a radical comprising from about one to about twenty carbon atoms, and R² is a radical comprising a photoreactive group, wherein the linking agent is bound to the surface of the substrate through the residue of the photoreactive group; and a desired compound disposed on the substrate, the desired compound selected from the group consisting of monomers, macromers, and polymers, the desired compound bound to the linking agent through the reaction product of the vinyl group on the linking agent.

In an embodiment, the invention includes a method of coating a surface of a substrate, the method including the steps of providing a photoreactive linking agent capable, upon activation, of covalent attachment to the surface of the substrate, the agent comprising a photoreactive group and a vinyl group; forming a coating composition comprising the linking agent and a solvent system; placing the coating composition in bonding proximity to the surface of the substrate, and activating the photoreactive groups of the linking agent in order to bond the photoreactive linking agent to the surface.

In an embodiment, the invention includes a method of coating a surface of a substrate, the method including the steps of providing a photoreactive linking agent capable, upon activation, of covalent attachment to the surface of the substrate, the agent comprising a photoreactive group and a vinyl group; forming a coating composition comprising the linking agent, a polymer, and a solvent system; depositing the coating composition on the surface of the substrate, and activating the photoreactive groups of the linking agent in order to bond the polymer to the surface.

In an embodiment, the invention includes a method of priming a surface of a substrate, the method comprising the steps of forming a first coating composition comprising a first compound comprising a photoreactive group and a terminal halide; placing the first coating composition in bonding proximity to the surface of the substrate; activating the photoreactive group of the first compound in order to bond the photoreactive linking agent to the surface; forming a second coating composition comprising a second compound comprising a tertiary reactive amine and a vinyl group; placing the second coating composition in bonding proximity to the surface of the substrate; and reacting the tertiary reactive amine of the second compound with the terminal halide of the first compound such that the vinyl group is covalently bonded to surface of the substrate.

In an embodiment, the invention includes a compound having the formula R¹—X—R², wherein R¹ is a radical comprising a vinyl group, X is a radical comprising from about one to about twenty carbon atoms, and R² is a radical comprising a photoreactive group.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE FIGURES

The invention may be more completely understood in connection with the following drawings, in which:

FIG. 1 is a schematic view of a linking agent bonding a desired compound to the surface of a substrate in accordance with an embodiment herein. While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

The embodiments of the present invention described herein are not intended to be exhaustive or to limit the invention to the precise forms disclosed in the following detailed description. Rather, the embodiments are chosen and described so that others skilled in the art can appreciate and understand the principles and practices of the present invention.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

Embodiments herein can include linking agents and devices, including but not limited to medical devices that incorporate such linking agents, along with related methods. Linking agents of the present invention can be used to immobilize (e.g., by cross-linking) otherwise nonreactive molecules to a surface and/or to each other. Linking agents of the present invention can also be used to prepare a primed latent reactive surface, which can be used for the later application of a target molecule.

As used herein, the term “water soluble” shall refer to a linking agent having sufficient solubility to allow it to be effectively used under aqueous conditions.

In various embodiments, the linking agent can include a photo group (or photoreactive group) and a vinyl group. For example, embodiments of linking agents can include a linking agent having the general formula:

R¹—X—R²,

wherein R¹ is a radical containing a vinyl group, X is a radical comprising a backbone segment, and R² is a radical containing a photoreactive group.

The R¹ radical can include one or more vinyl groups. In various embodiments, the R¹ radical can include one or more ethyleneically unsaturated functional groups. For example, the R¹ radical can contain groups including, but not limited to, acrylate, methacrylate, ethacrylate, 2-phenyl acrylate, acrylamide, methacrylamide, allyl, methallyl, styrene, itaconate, and derivatives thereof.

X radicals can include those having a positive charge, negative charge, as well as those being charge neutral (such as at neutral pH in aqueous solution). Charged groups of the X radical can include, but are not limited to salts of organic acids (such as sulfonate, phosphonate, and carboxylate groups), onium compounds (such as quaternary ammonium, sulfonium, and phosphonium groups), and protonated amines, as well as combinations thereof. The remaining counterion can be provided by any suitable ionic species. For example, in the context of a quaternary ammonium the remaining anionic counterion can include, but is not limited to, chloride, bromide, iodine, or sulfate ion. In the context of a phosphonate group the remaining cationic counterion can include, but is not limited to, sodium, potassium, calcium, magnesium, and the like.

In some embodiments, the X radical can include from about one to about forty carbon atoms and can also include one or more heteroatoms. In some embodiments, the X radical can include from about one to about twenty carbon atoms and can also include one or more heteroatoms. In some embodiments, the X radical can include linear or branched C₁-C₁₀ alkyl. In some embodiments heteroatoms can include one or more of N, S, O, and P. In some embodiments heteroatoms can include one or more of N, O, and P. In some embodiments, the X radical can include (—CH₂—)ₙ wherein n is an integer from 1 to 10. In some embodiments, the X radical can include (—O—CH₂—CH₂—)ₙ wherein n is an integer from 1 to 10.

The R² radical can include one or more photoreactive groups. As used herein, the term “photoreactive group” refers to a molecule or portion thereof having one or more functional groups that are capable of responding to a specific applied external stimulus to undergo active specie generation and form a covalent bond with an adjacent chemical structure, which can be provided by the same or a different molecule. Photoreactive groups are those groups of atoms in a molecule that retain their covalent bonds unchanged under conditions of storage but that, upon activation by an external energy source, form one or more covalent bonds with other molecules. In one embodiment, the photoreactive groups can generate active species such as free radicals upon absorption of electromagnetic energy. Photoreactive groups can be chosen to be responsive to various portions of the electromagnetic spectrum, including, for example, the ultraviolet and visible portions of the spectrum. Photoreactive groups are described, for example, in U.S. Pat. No. 5,002,582, the disclosure of which is incorporated herein by reference.

In various embodiments, the photoreactive group includes a photoreactive aryl ketone, such as acetophenone, benzophenone, anthraquinone, anthrone, and anthrone-like heterocycles (i.e., heterocyclic analogs of anthrone such as those having N, O, or S in the 10- position), or their substituted (e.g., ring substituted) derivatives. Examples of aryl ketones include heterocyclic derivatives of anthrone, including acridone, xanthone, and thioxanthone, and their ring substituted derivatives. One example includes thioxanthone, and its derivatives, having excitation energies greater than about 360 nm. In one embodiment, the photoreactive group is a functionalized benzophenone with an amine or hydroxyl substituent at positions 3 or 4 (i.e., 3- or 4-aminobenzophenone or 3- or 4-hydroxybenzophenone). As discussed above, the functionalized benzophenone can include a linker between the benzophenone photoreactive group and the amine or hydroxyl substituent. Examples of linkers include an amine, an ether, linear or branched C₁-C₁₀ alkyl, or a combination thereof.

The functional groups of such ketones are readily capable of undergoing the activation/inactivation/reactivation cycle described herein. Benzophenone is one example of a photoreactive moiety that is capable of photochemical excitation with the initial formation of an excited singlet state that undergoes intersystem crossing to the triplet state. The excited triplet state can insert into carbon-hydrogen bonds by abstraction of a hydrogen atom (from a support surface, for example), thus creating a radical pair. Subsequent collapse of the radical pair leads to formation of a new carbon-carbon bond. If a reactive bond (e.g., carbon-hydrogen) is not available for bonding, the ultraviolet light-induced excitation of the benzophenone group is reversible and the molecule returns to ground state energy level upon removal of the energy source. Photoactivatible aryl ketones such as benzophenone and acetophenone are subject to multiple reactivation in water and may increase coating efficiency.

The azides constitute one class of photoreactive groups and include derivatives based on arylazides (C₆R₅N₃) such as phenyl azide and particularly 4-fluoro-3-nitrophenyl azide, acyl azides (—CO—N₃) such as benzoyl azide and p-methylbenzoyl azide, azido formates ('O—CO-N₃) such as ethyl azidoformate, phenyl azidoformate, sulfonyl azides (—SO₂—N₃) such as benzenesulfonyl azide, and phosphoryl azides (RO)₂PON₃ such as diphenyl phosphoryl azide and diethyl phosphoryl azide. Diazo compounds constitute another class of photoreactive groups and include derivatives of diazoalkanes (—CHN₂) such as diazomethane and diphenyldiazomethane, diazoketones (—CO—CHN₂) such as diazoacetophenone and 1-trifluoromethyl-l-diazo-2-pentanone, diazoacetates (—O—CO—CHN₂) such as t-butyl diazoacetate and phenyl diazoacetate, and beta-keto-alpha-diazoacetates (—CO—CN₂ —CO—O—) such as t-butyl alpha diazoacetoacetate. Other photoreactive groups include the diazirines (—CHN₂) such as 3-trifluoromethyl-3-phenyldiazirine, and ketenes (—CH═C═O) such as ketene and diphenylketene.

Exemplary photoreactive groups, and their residues upon activation, are shown as follows.

| Photoreactive Group | Residue |
|---|---|
| aryl azides | amine (R—NH—R′) |
| acyl azides | amide (R—CO—NH—R′) |
| azidoformates | carbamate (R—O—CO—NH—R′) |
| sulfonyl azides | sulfonamide (R—SO₂—NH—R′) |
| phosphoryl azides | phosphoramide ((RO)₂PO—NH—R′) |
| diazoalkanes | new C—C bond |
| diazoketones | new C—C bond and ketone |
| diazoacetates | new C—C bond and ester |
| beta-keto-alpha-diazoacetates | new C—C bond and beta-ketoester |
| aliphatic azo | new C—C bond |
| diazirines | new C—C bond |
| ketenes | new C—C bond |
| photoactivated ketones | new C—C bond and alcohol |

Photoinitiation of free radicals can take place via various mechanisms, including photochemical intramolecular photocleavage, hydrogen abstraction, and redox reactions.

In one embodiment, photoinitiation takes place by hydrogen abstraction from the polymerizable groups.

Intramolecular photocleavage involves a homolytic alpha cleavage reaction between a carbonyl group and an adjacent carbon atom. This type of reaction is generally referred to as a Norrish type I reaction. Examples of molecules exhibiting Norrish type I reactivity and useful in a polymeric initiating system include derivatives of benzoin ether and acetophenone. For example, in one embodiment wherein the linking agent is provided in the form of a quinone having adjacent carbonyl groups (e.g., camphorquinone), photoinitiation takes place via intramolecular bond cleavage.

A second mechanism, hydrogen abstraction, can be either intra- or intermolecular in nature. A system employing this mechanism can be used without additional energy transfer acceptor molecules and by nonspecific hydrogen abstraction. However, this system is more commonly used with an energy transfer acceptor, typically a tertiary amine, which results in the formation of both aminoalkyl radicals and ketyl radicals. Examples of molecules exhibiting hydrogen abstraction reactivity and useful in a polymeric initiating system, include analogs of benzophenone and camphorquinone. Intramolecular hydrogen abstraction includes, but is not limited to, Norrish type II reactions.

A third mechanism involves photosensitization reactions utilizing photoreducible or photo-oxidizable dyes. In most instances, photoreducible dyes are used in conjunction with a reductant, typically a tertiary amine. The reductant intercepts the induced triplet producing the radical anion of the dye and the radical cation of the reductant.

In one embodiment, photoinitiation generates active species such as free radicals, including nitrenes, carbenes, and excited states of ketones upon absorption of electromagnetic energy. This excited photoinitiator in turn abstracts hydrogen atoms from available sources in proximity to the photoinitiator, e.g., polymerizable species. This hydrogen abstraction thus generates a free radical site within the polymerizable species from which polymerization can proceed.

In various embodiments, the linking agent is water soluble. By way of example, in various embodiments, the linking agent has a water solubility of at least about 0.1 mg/ml (at 25 degrees Celsius and neutral pH). In some embodiments, the linking agent has a water solubility of at least about 0.5 mg/ml (at 25 degrees Celsius and neutral pH). In some embodiments, the linking agent has a water solubility of at least about 1.0 mg/ml (at 25 degrees Celsius and neutral pH).

In other embodiments, the linking agent is water insoluble. For example, in some embodiments, the linking agent has a water solubility of less than about 0.1 mg/ml (at 25 degrees Celsius and neutral pH). In some embodiments, the linking agent has a water solubility of less than about 0.01 mg/ml (at 25 degrees Celsius and neutral pH).

### Preparation of Linking Agents

Linking agents of the present invention can be prepared using available reagents and chemical conversions within the skill of those in the relevant art. For instance, quaternary ammonium salts can be prepared by the reaction of tertiary amines with alkyl halides using the Menschutkin reaction (Z. Physik. Chem. 5, 589 (1890)). The reaction rates of such conversions can be enhanced by the use of highly nucleophilic tertiary amines, together with alkyl halides having easily displaced halide anions. Typically, the order of reactivity is I>Br>Cl, with primary halides and other highly reactive compounds such as benzylic halides being most reactive.

The following reaction diagram is illustrative of one general synthetic approach:

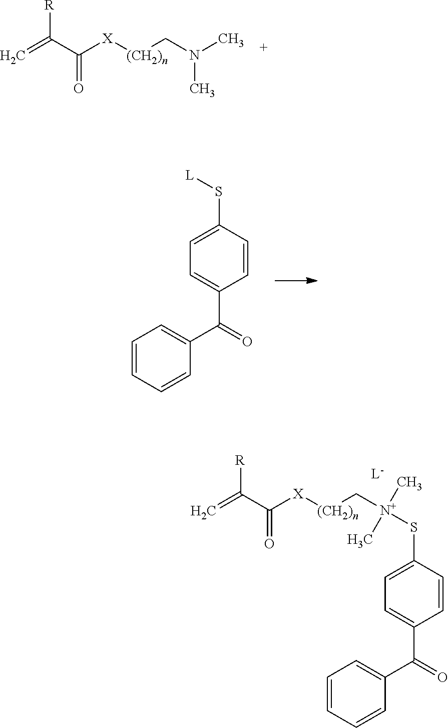

wherein R═H or CH₃; S=a spacer; L=a leaving group (e.g., triflate, mesylate, tosylate, halide, etc.); X═NH or O; and n=1 or 2.

In addition, the following reaction diagram illustrates one example of a synthetic approach for making a compound with two quaternary amines:

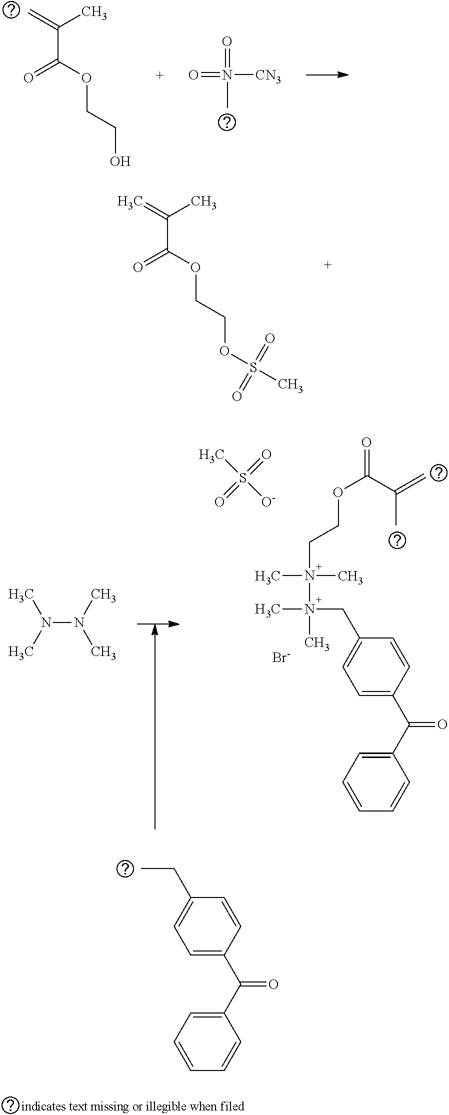

The following reaction diagram illustrates one example of a synthetic approach for making linking agents with a phosphonate group:

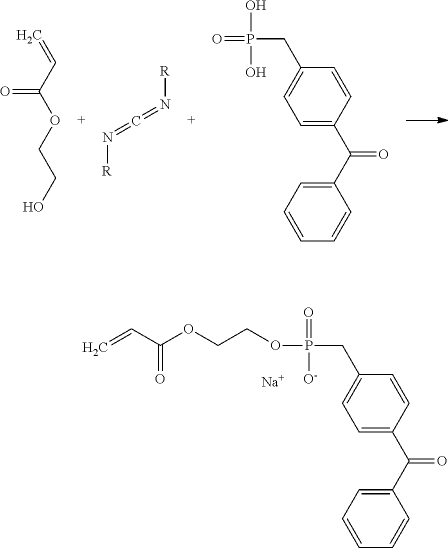

While it will be appreciated that many different linking agents are within the scope of the present application, Table I shows specific examples of linking agents included herein:

TABLE I

| Structure | Identifier | Charge |
|---|---|---|
| 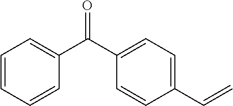 [SMILES: C=Cc1ccc(C(=O)c2ccccc2)cc1] | I | Neutral |
| 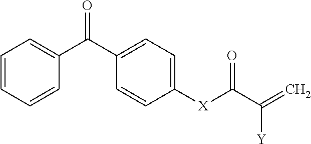 wherein X is O or NH and Y is H or CH₃ | II | Neutral |
| 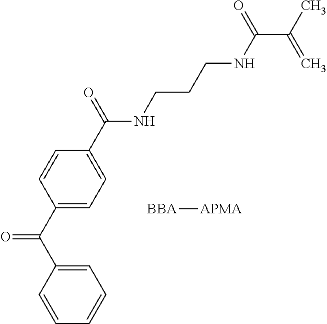 | III | Neutral |
| 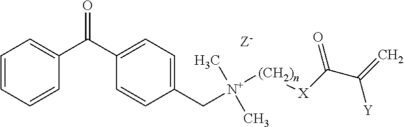 wherein X is O or NH, Y is H or CH₃, Z is an anion, and n is from 1 to 10. | IV | Positive |
| 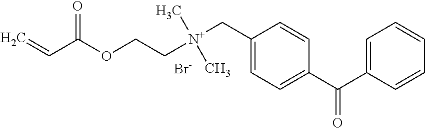 [SMILES: C=CC(=O)OCC[N+](C)(C)Cc1ccc(C(=O)c2ccccc2)cc1 ; [Br-]] | V | Positive |
| 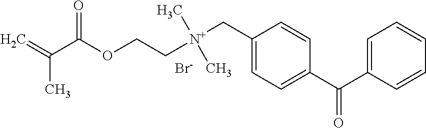 [SMILES: C=C(C)C(=O)OCC[N+](C)(C)Cc1ccc(C(=O)c2ccccc2)cc1 ; [Br-]] | VI | Positive |
| 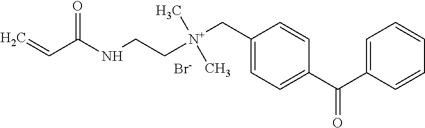 [SMILES: C=CC(=O)NCC[N+](C)(C)Cc1ccc(C(=O)c2ccccc2)cc1 ; [Br-]] | VII | Positive |
| 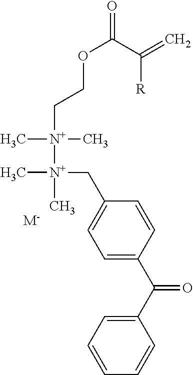 wherein R is H or CH₃, and M⁻ is a anion. | VIII | Positive |
| 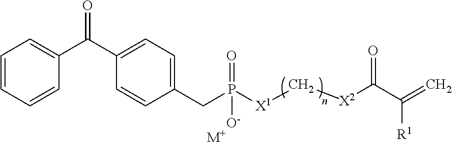 wherein X¹ is O or NH, X² is O or NH, R¹ is H or CH₃, M⁺ is a cation, and n is from 1 to 10. | IX | Negative |

### Further Applications

Linking agents included herein can be usefully applied in various applications. By way of example, in some embodiments, such linking agents can be used in order to prime the surfaces of a substrate. In some embodiments, such linking agents can be used in order to bond polymers to the surfaces of substrate. In some embodiments, linking agents herein can be used in order to form a coating on the surface of a substrate. In some embodiments, such linking agents can be used in order to cross-link polymers.

In one embodiment, the linking agent described herein is applied to a surface having carbon-hydrogen bonds with which the photoreactive groups can react to immobilize the linking agents. In one embodiment, the support surface provides abstractable hydrogen atoms suitable for covalent bonding with the activated group. In another embodiment, the surface can be modified (e.g., by pretreatment with a suitable reagent) to provide abstractable hydrogen atoms on the surface.

In an embodiment, the invention includes a method of priming a surface of a substrate. The method can include steps of providing a photoreactive linking agent capable, upon activation, of covalent attachment to the surface of the substrate, the agent comprising a photoreactive group and a vinyl group. The method can further include forming a coating composition comprising the linking agent and a solvent system. The solvent system can include one or more solvents. The method can further include placing the coating composition in bonding proximity to the surface of the substrate. The method can further include activating the photoreactive groups of the linking agent in order to bond the photoreactive linking agent to the surface.

In some embodiments, after priming a surface with a photoreactive linking agent including a photoreactive group and a vinyl group, the vinyl group can be used in polymerization reactions such as graft polymerization with monomers or macromers added onto the surface.

In some embodiments, the linking agent is used to form a coating on a substrate surface. In some embodiments, the coating is hydrophobic. In other embodiments, the coating is hydrophilic. The coating can be formed in any suitable manner, e.g., by simultaneous or sequential attachment of the linking agent and a compound or agent to be bonded (or “desired compound”) to a support surface.

In some embodiments, the method involves simultaneous application of a linking agent and a compound or agent to be bonded (or “desired compound”), in the same solution or in two separate solutions, to a substrate followed by activation of the photoreactive groups in the linking agent. The compound to be bonded can include various components, both polymeric and non-polymeric. In some embodiments, the agent to be bonded can be selected from the group consisting of monomers, macromers, and polymers.

The method of coating a surface of a substrate can include providing a photoreactive linking agent capable, upon activation, of covalent attachment to the surface of the substrate, the agent comprising a photoreactive group and a vinyl group.

The method further includes forming a coating composition comprising the linking agent, a polymer, and a solvent system. The solvent system can include one or more solvents. It will be appreciated that many different solvents can be used depending on the solubility properties of the particular linking agent used and the agent to be bonded. In some embodiments, the solvent system can be aqueous. In some embodiments, the solvent system can include water and a co-solvent, such as isopropanol. In some embodiments, the solvent system includes at least 50 percent isopropanol by volume.

The method can also include depositing the coating composition on the surface of the substrate. This can be accomplished in any suitable manner. Various techniques can be used including dip coating, spray coating (ultrasonic or gas atomization), brush coating, knife coating, roller coating, and the like.

The method can also include activating the photoreactive groups of the linking agent in order to bond the desired compound to the surface. Activation can be achieved in various ways. For example, the solution can be illuminated in situ to activate the photoreactive group(s) that serve as a photoinitiator(s), thus initiating attachment via hydrogen abstraction. Specifically, the surface can be illuminated with UV light of the appropriate wavelength, thereby activating the photoreactive groups on the linking agent. The linking agent is thus immobilized to the surface, by means of the photoreactive group. Simultaneously, the desired compound is bonded to the linking agent through the residue of the vinyl group. In some embodiments, activation takes place in an inert atmosphere. Deoxygenation can take place using an inert gas such as nitrogen.

In some embodiments, activation is carried out after application of the coating composition to the substrate, but before the coating composition dries (e.g., before the solvent evaporates off). In other embodiments, activation is carried out after application of the coating composition to the substrate and after the coating composition dries. While not intending to be bound by theory, it believed that various advantages can be achieved by activating the photoreactive groups before the coating composition dries. For example, in some cases the resulting coating is more durable.

In other embodiments, the method involves a two phase process, involving sequential steps in which linking agent is first attached to the surface, after which the desired compound is bonded thereto using the vinyl group of the attached linking agent.

As such, in some embodiments the invention includes a method of coating a surface of a substrate including the steps of providing a photoreactive linking agent capable, upon activation, of covalent attachment to the surface of the substrate, the agent comprising a photoreactive group and a vinyl group. The method also includes forming a coating composition comprising the linking agent and a solvent system. The method further includes placing the coating composition in bonding proximity to the surface of the substrate, and activating the photoreactive groups of the linking agent in order to bond the photoreactive linking agent to the surface. Optionally, unbounded linking agent can be washed away. Then, in the second phase of the process the method can include depositing the desired compound onto the now primed surface and covalently bonding it to the photoreactive linking agent through reaction with the vinyl group. It will be appreciated that method may also include various steps such as rinsing, washing, etc. In other various embodiments, the second phase may be omitted such that the method is one of priming the surface of a substrate.

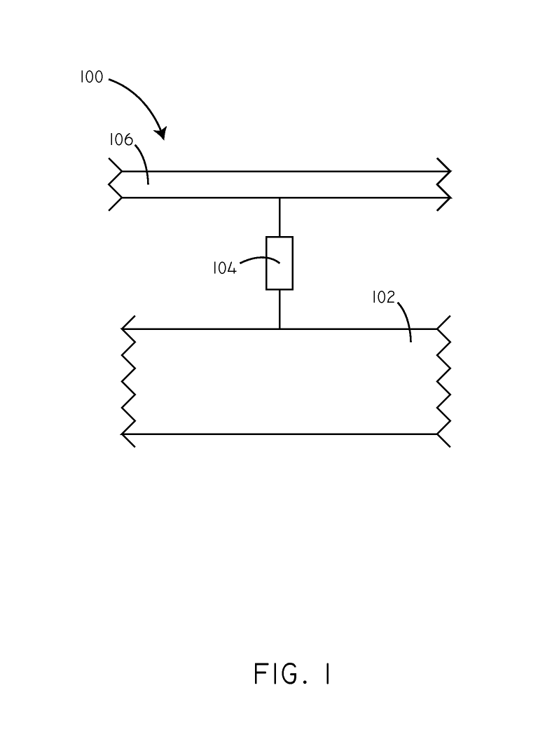

Referring now to FIG. 1, a schematic diagram of a portion of a device 100 illustrating a linking agent bonding a desired compound to the surface of a substrate is shown in accordance with an embodiment herein. The substrate 102 can include various materials as described in further detail below. In some embodiments, the substrate 102 includes abstractable hydrogen groups on its surface. In some embodiments, the substrate 102 is primed or otherwise modified to include abstractable hydrogen groups on its surface. The linking agent 104 serves to bind the desired compound 106 (illustrated here as a layer) to the substrate 102. The linking agent 104 can also have other applications. For example, in some embodiments (not shown), the linking agent 104 may also serve to form cross-links within the layer of the desired compound 106.

In an embodiment, the surface of a substrate can be primed or coated by first attaching a compound having a photoreactive group through activation of the photoreactive group and then, after optionally rinsing away unbound reagent, adding another reagent that is reactive with the bound compound to provide a vinyl group. As such, in an embodiment a method of priming a surface of a substrate is included having the steps of forming a first coating composition comprising a first compound comprising a photoreactive group and a terminal halide. By way of example, suitable compounds can include, but are not limited to, benzyl halides such as bromomethylbenzophenone (BMBP). The method can also include placing the first coating composition in bonding proximity to the surface of the substrate and activating the photoreactive group of the first compound in order to bond the photoreactive linking agent to the surface. The method can further include forming a second coating composition comprising a second compound comprising a tertiary reactive amine and a vinyl group. The method can also include placing the second coating composition in bonding proximity to the surface of the substrate; and reacting the tertiary reactive amine of the second compound with the terminal halide of the first compound such that the vinyl group is covalently bonded to surface of the substrate.

### Substrates

It will be appreciated that the method described herein is suitable for use in connection with a variety of support surfaces, including hydrogel polymers, silicone, polypropylene, polystyrene, poly(vinyl chloride), polycarbonate, poly(methyl methacrylate), parylene and any of the numerous organosilanes used to pretreat glass or other inorganic surfaces. The photoreactive linking agents can be applied to surfaces in any suitable manner (e.g., in solution or by dispersion), then photoactivated by uniform illumination to immobilize them to the surface. Examples of suitable hydrogel polymers are selected from silicone hydrogels, hydroxyethylmethacrylate polymers, and glyceryl methacrylate polymers.

Other suitable surface materials include polyolefins, polystyrenes, poly(methyl)methacrylates, polyacrylonitriles, poly(vinylacetates), poly(vinyl alcohols), chlorine-containing polymers such as poly(vinyl) chloride, polyoxymethylenes, polycarbonates, polyamides, polyimides, polyurethanes, phenolics, amino-epoxy resins, polyesters, silicones, cellulose-based plastics, and rubber-like plastics. See generally, “Plastics,” pp. 462-464, in Concise Encyclopedia of Polymer Science and Engineering, Kroschwitz, ed., John Wiley and Sons, 1990, the disclosure of which is incorporated herein by reference. In addition, supports such as those formed of pyrolytic carbon and silylated surfaces of glass, ceramic, or metal are suitable for surface modification.

Other surface materials that can be used in the present methods disclosed herein include metal surfaces. Exemplary metal surfaces can include, but are not limited to, stainless steel, nickel titanium alloys such as nitinol, chromium alloys such as Co—Cr—Mo and Cr—Ni—Cr—Mo and the likes.

Such materials can be used to fabricate a number of devices capable of being provided, either before, during and/or after their fabrication, with a polymer layer.

Implant devices are one general class of suitable devices, and include, but are not limited to, vascular devices such as grafts, stents, catheters, valves, artificial hearts, and heart assist devices; orthopedic devices such as joint implants, fracture repair devices, and artificial tendons; dental devices such as dental implants and fracture repair devices; ophthalmic devices such as lenses and glaucoma drain shunts; and other catheters, synthetic prostheses and artificial organs. Other suitable biomedical devices include dialysis tubing and membranes, blood oxygenator tubing and membranes, blood bags, sutures, membranes, cell culture devices, chromatographic support materials, biosensors, and the like.

### Compounds to be Bonded

In various embodiments the linking agent is used to bond a desired compound to the surface of a substrate. In some embodiments, the desired compound can include one or more polymerizable groups. In accordance with such an embodiment, the photoreactive group serves as an initiator to initiate polymerization of the polymerizable groups. As used herein, “polymerizable group” refers to a group that is adapted to be polymerized by initiation via free radical generation, and by photoinitiators activated by visible or long wavelength ultraviolet radiation.

A variety of desired compounds are suitable for use as with the linking agent described herein. In one embodiment, the desired compound is hydrophilic or is capable of being modified to provide hydrophilic characteristics at appropriate reaction conditions (e.g., pH). Desired compounds to be bonded can include polymers and non-polymers. In some embodiments, desired compounds are selected from monomeric polymerizable molecules (e.g., monomers), and macromeric polymerizable molecules (e.g., macromers), and polymers. As used herein, “macromer” shall refer to a macromolecular monomer having a molecular weight of about 250 to about 25,000, and from about 1,000 to about 5,000.

Suitable desired compounds can contain electrically neutral hydrophilic functional units, for example, acrylamide and methacrylamide derivatives. Examples of suitable monomers containing electrically neutral hydrophilic structural units include acrylamide, methacrylamide, N-alkylacrylamides (e.g., N,N-dimethylacrylamide or methacrylamide, N-vinylpyrrolidinone, N-vinylacetamide, N-vinyl formamide, hydroxyethylacrylate, hydroxyethylmethacrylate, hydroxypropyl acrylate or methacrylate, glycerolmonomethacrylate, and glycerolmonoacrylate).

Alternatively, suitable desired compounds containing electrically neutral hydrophilic functional units include molecules whose polymers, once formed, can be readily modified (e.g., hydrolyzed by the addition of ethylene oxide) to provide products with enhanced affinity for water. Examples of suitable monomers of this type include glycidyl acrylate or methacrylate, whose polymers bear epoxy groups that can be readily hydrolyzed to provide glycol structures having a high affinity for water.

Examples of suitable monomeric desired compounds that are negatively charged at appropriate pH levels include acrylic acid, methacrylic acid, maleic acid, fumaric acid, itaconic acid, AMPS (acrylamidomethylpropane sulfonic acid), vinyl phosphoric acid, vinylbenzoic acid, and the like.

Alternatively, suitable monomeric desired compounds that are negatively charged at appropriate pH levels include molecules whose polymers, once formed, can be readily modified (e.g., by hydrolysis via the addition of ethylene oxide) to provide products with enhanced affinity for water. Examples of suitable monomers of this type include maleic anhydride, whose polymers bear anyhdride groups that can be readily hydrolyzed to provide carboxylic acid groups, or can be readily reacted with amines to provide amide/acid structures with high affinity for water, and polymerized vinyl esters.

Examples of suitable monomeric desired compounds that are positively charged at appropriate pH levels include 3-aminopropylmethacrylamide (APMA), methacrylamidopropyltrimethylammonium chloride (MAPTAC), N,N-dimethylaminoethylmethacrylate, N,N-diethylaminoethylacrylate, and the like.

Alternatively, suitable positively charged monomeric desired compounds include those molecules that can be readily modified (e.g., by hydrolysis via the addition of ethylene oxide) to provide products with enhanced affinity for water as well as a positive charge, e.g., glycidyl methacrylate whose polymeric products can be reacted with amines (e.g., ethylamine), to provide hydroxyamino compounds. In some cases, these materials will contain a structural unit with an inherent positive charge, as for example with fully quaternized ammonium structures. In other cases, the positively charged structural unit will exist at certain pH values, particularly at acidic pH values.

In an alternative embodiment, the desired compounds include macromeric polymerizable molecules. Suitable macromers can be synthesized from monomers such as those illustrated above. Examples of suitable macromeric polymerizable compounds include methacrylate derivatives, monoacrylate derivatives, and acrylamide derivatives. Macromeric polymerizable compounds include poly(ethylene glycol)monomethyacrylate, methoxypoly(ethylene glycol)monomethacrylate, poly(ethylene glycol)monoacrylate, monomethyacrylamidopoly(acrylamide), poly(acrylamide-co-3-methacrylamidopropylacrylamide), poly(vinylalcohol)monomethacrylate, poly(vinylalcohol)monoacrylate, poly(vinylalcohol)dimethacrylate, and the like.

Such macromers can be prepared, for instance, by first synthesizing a hydrophilic polymer of the desired molecular weight, followed by a polymer modification step to introduce the desired level of polymerizable (e.g., vinyl) functional units. For example, acrylamide can be copolymerized with specific amounts of 3-aminopropylmethacrylamide comonomer, and the resulting copolymer can then be modified by reaction with methacrylic anhydride to introduce the methacrylamide functional units, thereby producing a useful macromer.

Poly(ethylene glycol) of a desired molecular weight can be synthesized or purchased from a commercial source, and modified (e.g., by reaction with methacrylyl chloride or methacrylic anhydride) to introduce the terminal methacrylate ester units to produce a suitable macromer. Some applications can benefit by use of macromers with the polymerizable units located at or near the terminus of the polymer chains, whereas other uses can benefit by having the polymerizable unit(s) located along the hydrophilic polymer chain backbone.

Such monomeric and macromeric polymerizable molecules can be used alone or in combination with each other, including for instance, combinations of macromers with other macromers, monomers with other monomers, or macromers combined with one or more small molecule monomers capable of providing polymeric products with the desired affinity for water. Moreover, the above polymerizable compounds can be provided in the form of amphoteric compounds (e.g., zwitterions), thereby providing both positive and negative charges.

### Polymer Foams

In another embodiment, the linking agent can be used in connection with a composition that is capable of in situ polymerization. In one embodiment, the linking agent can be used in connection with a polymer foam. Biodegradable foam used for the treatment of wounds are described, for example, in US Patent Publication No. 2009/0093550, the disclosure of which is hereby incorporated by reference herein in its entirety.

In one embodiment, a foam is formed using an “application composition” that includes a polymerizable component, a polymerization initiator, and a gas-releasing component. Suitable polymerization initiators include photoinitiators, including the photoreactive groups of the linking agent described herein. An application composition can be used to form biocompatible foam in situ, or as a pre-formed foam.

The biocompatible polymer foams can be formed from macromers that include polymerizable group(s). A polymerizable group generally includes a carbon-carbon double bond, which can be an ethylenically unsaturated group or a vinyl group. Upon initiation of a polymerization reaction in the application composition, the polymerizable groups, are activated by free radical propagation in the composition, and covalently bonded with other polymerizable groups. As a result of the covalent bonding a crosslinked polymeric matrix is formed. Gas bubbles are generated in the application composition by foaming agents while polymerization of the macromers (which causes polymer matrix formation) is occurring. As a result, a foam is formed, with air pockets (also referred to herein as “cells”) partially or completely surrounded by a wall of the crosslinked polymeric matrix.

Examples of polymerizable groups include, but are not limited to, acrylate groups, methacrylate groups, ethacrylate groups, 2-phenyl acrylate groups, acrylamide groups, methacrylamide groups, itaconate groups, and styrene groups. In some aspects the macromers of the invention include one or more methacrylate group(s).

Polymerizable groups can be “pendent” from the macromer at more than one location along the polymer backbone. In some cases the polymerizable groups are randomly located along the length of the polymer backbone. Such randomly spacing typically occurs when the macromer is prepared from a polymer having reactive groups along the length of the polymer, and the polymer is reacted with a limited molar quantity of a compound having the polymerizable group. For example, polysaccharides described herein have hydroxyl groups along the length of the polysaccharide, and a portion of these hydroxyl groups are reacted with a compound having a hydroxyl-reactive group and a polymerizable group.

In other cases one or more polymerizable groups are pendent from the macromer at one or more defined locations along the polymer backbone. For example, a polymer used for the synthesis of the macromer can have a reactive group at its terminus, or reactive groups at its termini. Many polymers prepared from monomers with reactive oxygen-containing groups (such as oxides) have hydroxyl-containing terminal ends which can be reacted with a compound having a hydroxyl-reactive group and a polymerizable group to provide the macromer with polymerizable groups at its termini.

The macromers are based on biocompatible polymers. The term “biocompatible” (which also can be referred to as “tissue compatible”) generally refers to the inability of a component, composition, or article to promote a measurably adverse biological response in the body. A biocompatible component, composition, or article can have one or more of the following properties: non-toxic, non-mutagenic, non-allergenic, non-carcinogenic, and/or non-irritating. A biocompatible component, composition, or article, in the least, can be innocuous and tolerated by the body. A biocompatible component, by itself, may also improve one or more functions in the body.

The present invention may be better understood with reference to the following examples. These examples are intended to be representative of specific embodiments of the invention, and are not intended as limiting the scope of the invention.

### EXAMPLES

### Example 1

### Synthesis of 2-acryloyloxy-N-(4-benzoylbenzyl)-N,N-dimethylethanaminium bromide (Compound A)

4-bromomethylbenzophenone (BMBP, prepared using a procedure similar to that found in example 1 of U.S. Pat. No. 5,714,360; 8.84 g; 32.13 mmole) was dissolved in chloroform (CHCl₃, 17 mL). To the warm BMBP solution was added 2-(dimethylamino)ethyl acrylate (4.6 g; 32.13 mmole; available from Sigma-Aldrich) in 1 mL increments. The reaction was exothermic. The reaction was left at room temperature overnight. The solution was added to diethyl ether (Et₂O; 250 mL) the mixture was stirred at room temperature overnight. The solid was isolated on a sintered glass funnel. The solid was resuspended in Et₂O (100 mL) and stirred for 3 hours. The solid was again isolated on a sintered glass funnel and rinsed with Et₂O (50 mL). The solid was dried in a vacuum oven at 40° C. overnight. The product amounted to 12.41 g (92% of theoretical). Compound A (structure shown below): Mp 115.8 (° C. by DSC on-set); ¹H NMR (400 MHz, CDCl₃) δ 3.46 (s, 6H), 4.22-4.28 (m, 2H), 4.72-4.78 (m, 2H), 5.43 (s, 2H), 5.91 (dd, 1H, J=1.2, 10.4), 6.10 (dd, 1H, J=10.4, 17.2), 6.44 (dd, 1H, J=1.2, 17.2), 7.48 (t, 2H, J=7.6), 7.61 (t, 1H, J=7.2), 7.76 (d, 2H, J=8.2), 7.81 (d, 2H, J=8), 7.94 (d, 2H, J=8.4).

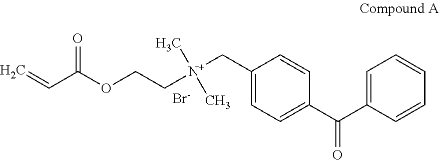 [SMILES: C=CC(=O)OCC[N+](C)(C)Cc1ccc(C(=O)c2ccccc2)cc1 ; [Br-]]

### Example 2

### Synthesis of N-(4-benzoylbenzyl)-2-(methacryloyloxy)-N,N-dimethylethanaminium bromide (Compound B)

The BMBP (8.75 g; 31.8 mmole) was dissolved in chloroform (CHCl₃, 17 mL). To the warm BMBP solution was added 2-(dimethylamino)ethyl methacrylate (5.0 g; 31.8 mmole); available from Sigma-Aldrich) in 1 mL increments. The reaction was exothermic. The reaction was left at room temperature overnight. The solution was added to diethyl ether (Et₂O; 250 mL) the mixture was stirred at room temperature overnight. The solid was isolated on a sintered glass funnel. The solid was resuspended in Et₂O (250 mL) and stirred for 3 hours. The solid was again isolated on a sintered glass funnel and rinsed with Et₂O (50 mL). The Compound B was dried in a vacuum oven at 40° C. overnight. The product amounted to 12.44 g (90% of theory). Compound B (structure shown below): Mp 154.8 (° C. by DSC on-set); ¹H NMR (400 MHz, CDCl₃) δ 1.91 (s, 3H), 3.47 (s, 6H), 4.24-4.30 (m, 2H), 4.70-4.76 (m, 2H), 5.44 (s, 2H), 5.63 (s, 1H), 6.12 (s, 1), 7.48 (t, 2H, J=7.6), 7.61 (t, 1H, J=7.2), 7.76 (d, 2H, J=8.2), 7.81 (d, 2H, J=8), 7.94 (d, 2H, J=8.4).

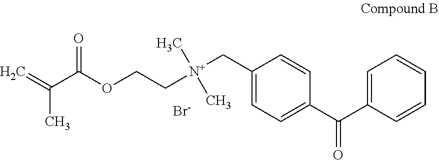 [SMILES: C=C(C)C(=O)OCC[N+](C)(C)Cc1ccc(C(=O)c2ccccc2)cc1 ; [Br-]]

### Example 3

### Synthesis of N-[2-(dimethylamino)ethyl]acrylamide (DMA-EA; compound C)

Acryloyl chloride (10.27 g; 113.4 mmole) was placed in a flask along with CHCl₃ (40 mL), phenothiazine (100 mg; 0.50 mmole), and a magnetic stir bar. The reaction was protected from moisture with a drying tube. The reaction was cooled in an ice bath to a temperature <5° C. throughout the addition of the N,N-dimethylethane-1,2-diamine (10.0 g, 113.4 mmole; available from Sigma-Aldrich), which was added at a rate of 0.1 mL/min. The reaction was stirred while warming to room temperature (R.T.), and stirred at R.T. for an additional hour. The reaction was transferred to a reparatory funnel using CHCl₃ (100 mL) and aq NaOH (100 mL of 2 N). The aqueous layer was extracted a second time with CHCl₃ (50 mL). Potassium carbonate (20 g) was added to the aqueous layer, which was extracted with 2 portions of CHCl₃ (100 mL). All 4 extractions were combined and dried by passing through a column 4.4 cm in diameter, which contained Na₂CO₃ (1.3 cm in height) on top of Na₂SO₄ (2.5 cm in height). The CHCl₃ solution (˜330 mL) was purified on a silica gel column 8 cm diameter and 150 mm high (used 293 g of flash grade silica). The column was eluted with methanol (from 5% to 20%) in chloroform. Fractions containing product analyzed by TLC were combined and evaporated to give a DMA-EA (˜7 g). DMA-EA (structure shown below): R_{f}=0.28 (20% MeOH in CHCl₃); ¹H NMR (400 MHz, CDCl₃) δ 2.23 (s, 6H), 2.44 (t, 2H, J=6.0 Hz), 3.40 (dt, 2H, J=5.6, 5.6), 5.61 (dd, 1H, J=1.6, 10.2), 6.11 (dd, 1H, J=10.2, 17.0), 6.27 (dd, 1H, J=1.6, 17.0), 6.2-6.5 (brm, 1H).

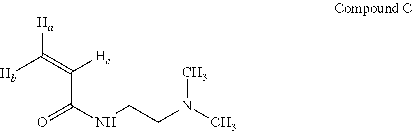

### Example 4

### Synthesis of 2-(acryloylamino)-N-(4-benzoylbenzyl)-N,N-dimethylethanaminium bromide (Compound D)

The BMBP (9.67 g; 35.16 mmole) was dissolved in chloroform (CHCl₃, 18 mL). To the warm BMBP solution was added DMA-EA (5.0 g; 35.16 mmole) in 1 mL increments. The reaction was exothermic. The reaction was left at room temperature overnight. The solution was added to diethyl ether (Et₂O; 200 mL) the mixture was stirred about 2 hours at room temperature. The solid was isolated on a sintered glass funnel. The solid was resuspended in Et₂O (200 mL) and stirred over the weekend. The solid was again isolated on a sintered glass funnel and rinsed with Et₂O (50 mL). The solid was dried in a vacuum oven at 40° C. overnight. The dried solid (Compound D) amounted to 13.27 g (90% of theory). Compound D (structure shown below): Mp 116.6 (° C. by DSC on-set); ¹H NMR (400 MHz, CDCl₃) δ 3.39 (s, 6H), 3.90-4.00 (m, 4H), 5.11 (s, 2H), 5.64 (dd, 1H, J=2.6. 9.0), 6.25-6.41 (m, 2H), 7.48 (t, 2H, J=7.8), 7.61 (t, 1H, J=7.2), 7.76 (d, 2H, J=8), 7.82-7.86 (m, 4H), 8.70 (brt, 1H, J=6.4); mass spectrum (ESI): m/e (% relative intensity) 377.7 (84) (M⁺, without Br⁻).

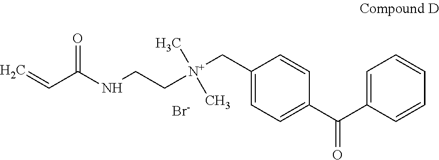 [SMILES: C=CC(=O)NCC[N+](C)(C)Cc1ccc(C(=O)c2ccccc2)cc1 ; [Br-]]

### Example 5

### Preparation of 2-(acryloylamino)ethyl hydrogen (4-benzoylbenzyl)phosphonate

(4-benzoylbenzyl)phosphonic acid (1.00 g; 3.62 mmole), N-(2-hydroxyethyl)acrylamide (0.417 g; 3.62 mmole), N,N-dimethylpyridin-4-amine (DMAP, 22 mg; 0.18 mmole), and 1,4-dioxane (dioxane, 10 ml) were placed in a Vial (40 ml) and heated at a temperature below the boiling point of dioxane until all solids were dissolved to give solution (A). The N,N-dicyclohexylcarbodiimide (DCC, 0.747 g; 3.62 mmole) was dissolved in dioxane (5 ml) to give solution (B). Solution (B) was slowly (˜0.26 ml/min.) added to solution (A), which had cooled to room temperature. A precipitate formed as the addition proceeded. The reaction was stirred at room temperature overnight. The temperature was kept at room temperature throughout the reaction from addition until the workup. The mixture was filtered to remove the 1,3-dicyclohexylurea (DCU). The DCU was washed with 3×2 ml dioxane. The washes and filtrate were combined and evaporated about 10 minutes at 50 C and 50 mm Hg pressure. The viscous residue was stirred with diethyl ether (Et₂O, 12 ml) for 20 minutes. The Et₂O was decanted, and the residue was stirred with fresh Et₂O (20 ml) over night. The Et₂O was decanted, and the residue was dried using a stream if air for 2.5 hours. The crude product was analyzed by NMR and MS (Turbo Spray), which indicated the product to contain 50% of the desired reagent.

### Example 6

### Preparation of a Photo-Vinyl-Quat (Methacrylate) Solution

To a 20 ml clear glass vial, 29 mg of N-(4-benzoylbenzyl)-2-(methacryloyloxy)-N,N-dimethylethanaminium bromide or “PVQmethacrylate” (prepared as described in example 2 above) was added. Next 10 ml of IPA (isopropanol) was added along with 5 ml of deionized water and the vial shaken to mix to a clear solution. Finally 452 mg of polyvinylpyrrolidone or “PVPk90” (PVP K 90, obtained from BASF Corporation) was added and the vial mixed on an orbital shaker until a clear solution, resulting in a concentration of (PVQmethacrylate/PVPk90) at (2/30) mg per ml in 33% IPA and 67% water.

### Example 7

### Coating Multiple Substrates with PVQmethacrylate/PVPk90 Solution

The solution from example 5 was used to coat 4 different substrates: 3 mm PEEK (polyether ether ketone) rod, 3 mm blue 6333 PEBAX® (polyether block amide) rod, 1 mm gray 72D PEBAX® rod, and 1 mm clear 72D nylon (polyamide) rod (all substrates obtained from Medicine Lake Extrusions Inc., Plymouth, Minn.). The parts were cut to 7 cm lengths and cleaned by wiping with an IPA soaked Alpha 10 clean room wipe (ITW Texwipe, Kernersville, N.C.). The parts were hand dipped into the solution with a dwell time of about 15 seconds, then pulled out of the solution at about 0.75 cm/s. The parts were immediately placed into a UV light chamber (with rotation) using Dymax lamps (400 watt power supplies, and iron-doped mercury bulbs) and UV cured for 3 minutes. The parts went into the UV chamber wet and came out dry. The parts were then stained with a 0.35% Congo Red stain (in water) and rinsed. The hydrated parts were firmly squeezed between the thumb and fore finger (rubbed with a gloved hand) and pulled through, repeating up to 30 times, rotating a quarter of a turn each pull. The coating was found to be lubricious and durable on all 4 substrates, with 95-100% of the stained coating remaining

### Example 8

### Preparation of a Photo-Vinyl-Quat (Acrylate) Solution

To a 20 ml clear glass vial, 40 mg of 2-acryloyloxy-N-(4-benzoylbenzyl)-N,N-dimethylethanaminium bromide (prepared as described in example 1 above) or “PVQacrylate”, was added. Next 10 ml of IPA (isopropanol) was added along with 10 ml of deionized water and the vial shaken to mix to a clear solution. Finally 400 mg of polyvinylpyrrolidone or “PVPk90” (PVP K 90, obtained from BASF Corporation) was added and the vial mixed on an orbital shaker until a clear solution, resulting in a concentration of (PVQacrylate/PVPk90) at (2/20) mg per ml in 50% IPA and 50% water.

### Example 9

### Coating Multiple Substrates with PVQacrylate/PVPk90 Solution

The solution from example 7 was used to coat 3 different substrates: the blue and gray PEBAX rods from example 6 along with LDPE (low-density polyethylene) flats. The samples were dip coated, UV cured, and evaluated as in example 6 (wet-to-dry UV cure) and the coating was found to be very durable (90-100% of coating retained).

Another set of samples (same substrates) were allowed to air dry before curing. Within 30 seconds dewetting began to occur, especially on the LDPE flats. The majority of the remaining coating was removed on the LDPE flat and the gray PEBAX rod, but remained on the blue PEBAX rod.

### Example 10

### Preparation of a Photo-Vinyl-Quat (Acrylamide) Solution

To a 20 ml clear glass vial, 40 mg of 2-(acryloylamino)-N-(4-benzoylbenzyl)-N,N-dimethylethanaminium bromide (prepared as described in example 4 above) or “PVQacrylamide”, was added. Next 10 ml of IPA (isopropanol) was added along with 10 ml of deionized water and the vial shaken to mix to a clear solution. Finally 400 mg of PVPk90 (BASF) was added and the vial mixed on an orbital shaker until a clear solution, resulting in a concentration of (PVQacrylamide/PVPk90) at (2/20) mg per ml in 50% IPA and 50% water.

### Example 11

### Coating Blue 6333 PEBAX with PVQacrylamide/PVPk90 Solution

The solution from example 9 was used to coat blue PEBAX rods. The samples were dip coated, UV cured, and evaluated as in example 6 (wet-to-dry UV cure) and the coating was found to be very durable (95-100% of coating retained).

Another set (same substrate) was given a second coat and after evaluation the coating was found to be as durable as a 1-coat, but more lubricious.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

1. A device comprising:
a substrate;
a linking agent bound to the surface of the substrate through the residue of a photoreactive group, the linking agent having the formula R¹—X—R², wherein R¹ is a radical comprising a vinyl group, X is a radical comprising from about one to about twenty carbon atoms, and R² is a radical comprising a photoreactive group.

2. The device of claim 1, wherein X comprises from about one to 10 carbon atoms.

3. The device of claim 1, wherein X further comprises a heteroatom.

4. The device of claim 1, wherein X comprises a charged group.

5. The device of claim 1, wherein the linking agent is water soluble.

6. The device of claim 1, wherein the photoreactive group comprises an aryl ketone.

7. The device of claim 1, wherein the vinyl group is part of an acrylate group.

8. The device of claim 1, wherein R¹ comprises at least two vinyl groups.

9. The device of claim 1, the device comprising an implantable medical device.

10. A method of coating a surface of a substrate, the method comprising the steps of:
providing a photoreactive linking agent capable, upon activation, of covalent attachment to the surface of the substrate, the agent comprising a photoreactive group and a vinyl group;
forming a coating composition comprising the linking agent and a solvent system;
placing the coating composition in bonding proximity to the surface of the substrate, and
activating the photoreactive groups of the linking agent in order to bond the photoreactive linking agent to the surface.

11. The method of claim 10, further comprising:
depositing a desired compound selected from the group consisting of a monomer, macromer, and polymer on the photoreactive linking agent, and
covalently bonding the agent to the photoreactive linking agent through reaction with the vinyl group.

12. The method of claim 11, the linking agent having the formula R¹—X—R², wherein R¹ is a radical comprising a vinyl group, X is a radical comprising from about one to about twenty carbon atoms, and R² is a radical comprising a photoreactive group.

13. The method of claim 12, wherein X further comprises a heteroatom.

14. The method of claim 12, wherein X comprises a charged group.

15. The method of claim 12, wherein X is charge neutral in aqueous solution at a pH of 7.

16. The method of claim 10, wherein the linking agent is water soluble.

17. The method of claim 10, wherein the vinyl group is part of an acrylate group.

18. The method of claim 10, the substrate comprising a polymer.

19. A compound having the formula: 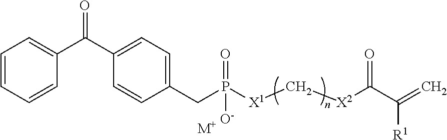
wherein
X¹ is selected from O and NH;
X² is selected from O and NH;
R¹ is selected from H and CH₃;
M⁺ is a cation; and
n is from 1 to 10.

20. A linking agent having formula R¹—X—R², wherein R¹ comprises a radical including vinyl group, X comprises a radical including a phosphorus atom, and R² comprises a radical including a photoreactive group.

21. The linking agent of claim 20, wherein X comprises a radical including from about one to 10 carbon atoms.

22. The linking agent of claim 20, wherein X further comprises a heteroatom selected from the group consisting of oxygen, nitrogen, and sulfur.

23. The linking agent of claim 20, wherein X comprises a charged group.

24. The linking agent of claim 20, wherein the photoreactive group comprises an aryl ketone.

25. The linking agent of claim 20, wherein the vinyl group is part of an acrylate group.
